(19) United States
(12) Patent Application Publication
(10) Pub. No.: US 2025/0373147 A1
(43) Pub. Date: Dec. 4, 2025

(54) POWER CONVERTER AND AIR CONDITIONER

(71) Applicant: Mitsubishi Electric Corporation, Tokyo (JP)

(72) Inventors: Takahiko KOBAYASHI, Tokyo (JP); Hiroki SUZUKI, Tokyo (JP); Yu OTORII, Tokyo (JP)

(21) Appl. No.: 18/876,224

(22) PCT Filed: Sep. 22, 2022
(86) PCT No.: PCT/JP2022/035362

§ 371 Date: Dec. 18, 2024

(51) Int. Cl. H02M 1/32; H02M 1/00; H02M 1/12; H02M 5/458; H02P 29/024

(52) U.S. Cl. CPC H02M 1/32; H02M 1/0022; H02M 1/007; H02M 1/12; H02M 5/4585; H02P 29/0241

(57) ABSTRACT

A power converter includes: a converter that rectifies alternating-current power; a first inverter and a second inverter; a first voltage detection circuitry that performs filtering of a detection value of a voltage input to the first inverter, and outputs the detection value as a first voltage detection value; a second voltage detection circuitry that performs filtering of a detection value of a voltage input to the second inverter, and outputs the detection value as a second voltage detection value; a first drive signal generator that performs, based on the first voltage detection value, operation of generating a drive signal for the first inverter and operation of protecting the first inverter; and a second drive signal generator that performs, based on the second voltage detection value, operation of generating a drive signal for the second inverter and operation of protecting the second inverter.

### CROSS-REFERENCE TO RELATED APPLICATION

This application is a U.S. national stage application of PCT/JP2022/035362 filed Sep. 22, 2022, the contents of which are incorporated herein by reference.

### FIELD

The present disclosure relates to a power converter and an air conditioner.

### BACKGROUND

As a conventional power converter, there is a power converter including a plurality of power conversion circuitries that convert power supplied from a common power source into a desired alternating-current power, and supply power. The power converter causes the power conversion circuitries to generate power necessary for a plurality of connected devices, and supplies the generated power to the connected devices.

For example, Patent Literature 1 discloses a power converter (motor drive circuitry) in which two inverters, that is, a first inverter and a second inverter, are connected to a rectifier circuitry that rectifies an alternating-current voltage of an alternating-current power supply, and the first inverter and the second inverter generate drive voltages for driving a fan motor and a compressor motor, respectively.

### PATENT LITERATURE

Patent Literature 1: Japanese Patent Application Laid-open No. 2020-61913

In the case of the circuitry configuration disclosed in Patent Literature 1, the two inverters are connected to a common bus. Therefore, voltages on input sides of the two inverters are ideally equal. However, when there is a difference between distances from an input bus to the inverters, there is also a difference between impedances of wires to the inverters. In particular, when a length of a bus between a converter (rectifier circuitry) and an inverter increases due to restrictions by layout inside the apparatus, wire impedance further increases. Furthermore, when a distance to one inverter is longer than a distance to the other inverter, the difference between the wire impedances increases. For example, when a motor drive circuitry serving as a power converter is applied to an air conditioner as described in Patent Literature 1, it is conceivable that a difference increases between a wire impedance of an electric circuitry that supplies power to a motor of a compressor provided in an outdoor unit and a wire impedance of an electric circuitry that supplies power to a motor of a fan provided in an indoor unit.

Here, when wire impedance increases, there occurs bus voltage fluctuation such as a transient surge caused by a sudden change in power supply voltage or a sudden change in current associated with a sudden change in a motor load on one side. The higher the wire impedance, the greater the transient voltage fluctuation and the higher the risk of overvoltage. Thus, higher overvoltage detection responsiveness is required for the purpose of protecting inverters. That is, when an overvoltage occurs, it is required to detect the overvoltage at an early stage and to cause a protection circuitry to quickly implement protection operation (protection function). Meanwhile, when wire impedance is small, the influence of noise from surroundings is larger than the influence of bus voltage fluctuation caused by the wire impedance. Thus, there is a concern that incorrect voltage detection due to the noise may affect motor control, or may cause false detection of an overvoltage anomaly. Therefore, in a case where a difference between impedances of wires from the converter to the inverters is large, an attempt to increase overvoltage detection responsiveness without consideration of the difference between wire impedances will increase the risk of a malfunction due to noise, such as an operation stop caused by the protection function, on a side where wire impedance is smaller. In addition, an attempt to suppress occurrence of a malfunction due to noise without consideration of the difference between wire impedances will reduce overvoltage detection responsiveness and increase the risk of failure of the apparatus due to delay in activation of the protection function on a side where wire impedance is larger, that is, where protection against an overvoltage is important.

It is required to reduce the influence of the difference between wire impedances caused by the difference between distances from the converter to the inverters due to restrictions by layout inside the apparatus.

### SUMMARY

The present disclosure has been made in view of the above, and an object of the present disclosure is to obtain a power converter capable of suppressing an influence of a difference between wire impedances between a converter and two inverters and implementing a highly reliable operation.

To solve the above problems and achieve the object, a power converter according to the present disclosure includes: a converter configured to rectify alternating-current power supplied from an alternating-current power supply; a first inverter and a second inverter each connected to both ends of a main circuitry capacitor that is configured to smooth direct-current power output from the converter; a first voltage detection circuitry configured to detect a voltage input to the first inverter and perform filtering of a detection value, and output the detection value as a first voltage detection value; a second voltage detection circuitry configured to detect a voltage input to the second inverter and perform filtering of a detection value, and output the detection value as a second voltage detection value; a first drive signal generator configured to perform, based on the first voltage detection value, operation of generating a drive signal for the first inverter and operation of protecting the first inverter when an anomaly occurs; and a second drive signal generator configured to perform, based on the second voltage detection value, operation of generating a drive signal for the second inverter and operation of protecting the second inverter when an anomaly occurs. At least either time constants of filter circuitries or threshold values are set based on wire impedances between the converter and the first inverter and between the converter and the second inverter. And the filter circuitries are configured to perform the filtering in the first voltage detection circuitry and the second voltage detection circuitry, and the threshold values are used in anomaly detection processes in the first drive signal generator and the second drive signal generator.

The power converter according to the present disclosure achieves an effect of suppressing an influence of a difference between wire impedances between a converter and each of two inverters and implementing a highly reliable operation.

### BRIEF DESCRIPTION OF DRAWINGS

FIG. 1 is a diagram illustrating an exemplary configuration of a power converter according to a first embodiment.

FIG. 2 is a diagram schematically illustrating wire impedances that the power converter according to the first embodiment has.

FIG. 3 is a diagram illustrating an exemplary configuration of a first voltage detection circuitry and a second voltage detection circuitry included in the power converter according to the first embodiment.

FIG. 4 is a flowchart illustrating exemplary operation of a first drive signal generator included in the power converter according to the first embodiment.

FIG. 5 is a diagram illustrating an exemplary configuration of a power converter according to a second embodiment.

FIG. 6 is a diagram illustrating an exemplary configuration of an air conditioner according to a third embodiment.

### DETAILED DESCRIPTION

Hereinafter, power converters and an air conditioner according to embodiments of the present disclosure will be described in detail with reference to the drawings.

### First Embodiment

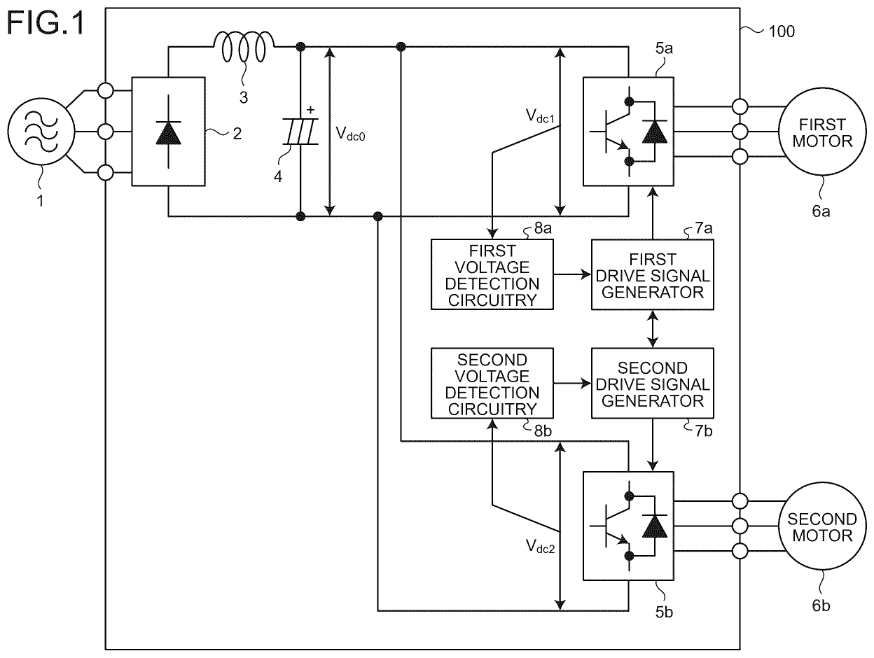

FIG. 1 is a diagram illustrating an exemplary configuration of a power converter 100 according to a first embodiment. The power converter 100 includes a converter 2, a reactor 3, a main circuitry capacitor 4, a first inverter 5a, a second inverter 5b, a first drive signal generator 7a, a second drive signal generator 7b, a first voltage detection circuitry 8a, and a second voltage detection circuitry 8b.

The converter 2 is connected to an alternating-current power supply 1, and rectifies and outputs three-phase alternating-current power supplied from the alternating-current power supply 1. The converter 2 may be a passive converter using a diode bridge, or may be a boost converter capable of boosting output voltage. The reactor 3 has one end connected to a positive-side output end of the converter 2, and has another end connected to one end of the main circuitry capacitor 4. Another end of the main circuitry capacitor 4 is connected to a negative-side output end of the converter 2. That is, the main circuitry capacitor 4 is connected to the another end of the reactor 3 and to the negative-side output end of the converter 2. In addition, the first inverter 5a and the second inverter 5b are connected to both ends of the main circuitry capacitor 4. A first motor 6a is connected to output ends of the first inverter 5a, and a second motor 6b is connected to output ends of the second inverter 5b.

The reactor 3 and the main circuitry capacitor 4 suppress harmonics of direct-current power output from the converter 2, and smooth the direct-current power output from the converter 2. A voltage across the main circuitry capacitor 4 is denoted by V_{dc0}. The first inverter 5a converts direct-current power input from the converter 2 via the reactor 3 and the main circuitry capacitor 4 into alternating-current power, and supplies the alternating-current power to the first motor 6a. The first inverter 5a performs operation of power conversion from direct current to alternating current according to a drive signal input from the first drive signal generator 7a to be described below. The second inverter 5b converts direct-current power input from the converter 2 via the reactor 3 and the main circuitry capacitor 4 into alternating-current power, and supplies the alternating-current power to the second motor 6b. The second inverter 5b performs operation of power conversion from direct current to alternating current according to a drive signal input from the second drive signal generator 7b to be described below.

The first drive signal generator 7a is configured to: generate a drive signal for controlling the power conversion operation of the first inverter 5a based on a voltage V_{dc1}, which is input to the first inverter 5a and detected by the first voltage detection circuitry 8a, and a voltage command (not illustrated) input from the outside; and output the drive signal to the first inverter 5a. The second drive signal generator 7b is configured to: generate a drive signal for controlling the power conversion operation of the second inverter 5b based on a voltage V_{dc2}, which is input to the second inverter 5b and detected by the second voltage detection circuitry 8b, and a voltage command (not illustrated) input from the outside; and output the drive signal to the second inverter 5b. Note that the first drive signal generator 7a and the second drive signal generator 7b generate drive signals by using a known general drive signal generation method. The first drive signal generator 7a and the second drive signal generator 7b are implemented by, for example, a microcontroller. The first drive signal generator 7a and the second drive signal generator 7b may be implemented by a single microcontroller, or may be implemented by separate microcontrollers.

The first voltage detection circuitry 8a is configured to: detect a voltage of an input portion of the first inverter 5a; and transmit, to the first drive signal generator 7a, a signal corresponding to the detected voltage V_{dc1} input to the first inverter 5a. The second voltage detection circuitry 8b is configured to: detect a voltage of an input portion of the second inverter 5b; and transmit, to the second drive signal generator 7b, a signal corresponding to the detected voltage V_{dc2} input to the second inverter 5b.

Furthermore, the first drive signal generator 7a and the second drive signal generator 7b have functions of causing the first inverter 5a and the second inverter 5b to stop power conversion operation, respectively, in a case where the power converter 100 fails or in a state where there is a concern about a failure of the power converter 100. For example, when the input voltage V_{dc1} detected by the first voltage detection circuitry 8a is larger than a predetermined threshold value, the first drive signal generator 7a determines that an overvoltage anomaly has occurred in which an excessive voltage is applied to the first inverter 5a, and causes the first inverter 5a to stop power conversion operation. Similarly, when the input voltage V_{dc2} detected by the second voltage detection circuitry 8b is larger than a predetermined threshold value, the second drive signal generator 7b determines that an overvoltage anomaly has occurred in which an excessive voltage is applied to the second inverter 5b, and causes the second inverter 5b to stop power conversion operation.

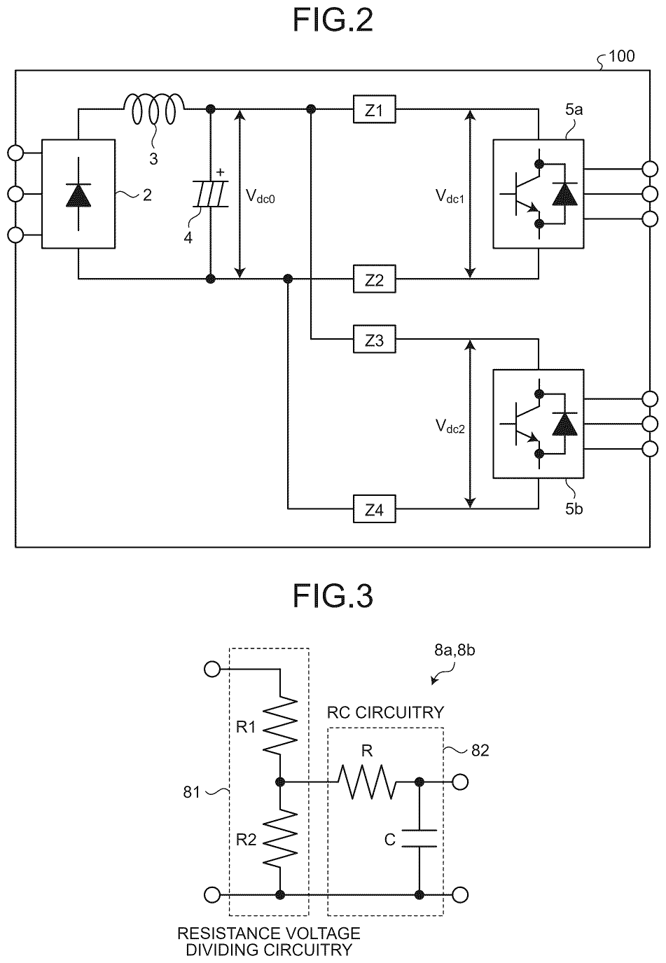

Here, wire impedances exist between the converter 2 and the first inverter 5a and between the converter 2 and the second inverter 5b of the power converter 100, as illustrated in FIG. 2. FIG. 2 is a diagram schematically illustrating wire impedances that the power converter 100 according to the first embodiment has. In FIG. 2: Z1 denotes an impedance of a wire from the main circuitry capacitor 4 to a positive-side input end of the first inverter 5a; Z2 denotes an impedance of a wire from the main circuitry capacitor 4 to a negative-side input end of the first inverter 5a; Z3 denotes an impedance of a wire from the main circuitry capacitor 4 to a positive-side input end of the second inverter 5b; and Z4 denotes an impedance of a wire from the main circuitry capacitor 4 to a negative-side input end of the second inverter 5b. The wire impedances Z1 to Z4 comprise minute resistance components and reactance components present on the wires. The wire impedances Z1 to Z4 cause a potential difference between V_{dc0} and V_{dc1}, a potential difference between V_{dc0} and V_{dc2}, and transient voltage fluctuation. Note that the first voltage detection circuitry 8a, the second voltage detection circuitry 8b, the first drive signal generator 7a, and the second drive signal generator 7b are omitted in FIG. 2.

An increase in a difference between the wire impedance (Z1, Z2) between the converter 2 and the first inverter 5a and the wire impedance (Z3, Z4) between the converter 2 and the second inverter 5b may cause a difference between response time taken to start protection operation for causing the first inverter 5a to stop power conversion operation and response time taken to start protection operation for causing the second inverter 5b to stop power conversion operation when an overvoltage occurs. This increases the possibility that an element may be damaged due to delay in protecting one of the inverters. In addition, a difference between the amounts of voltage fluctuation due to the influence of noise increases. This increases the possibility that an overvoltage anomaly may be erroneously detected to cause an unnecessary operation stop.

In order to suppress the influence of such a difference between wire impedances, the first voltage detection circuitry 8a and the second voltage detection circuitry 8b include filter circuitries, and time constants (hereinafter, referred to as filter time constants) of the filter circuitries are separately set in the power converter 100 according to the first embodiment. That is, setting the filter time constants of the filter circuitries to different values reduces the influence of the difference between the wire impedance between the converter 2 and the first inverter 5a and the wire impedance between the converter 2 and the second inverter 5b.

FIG. 3 is a diagram illustrating an exemplary configuration of the first voltage detection circuitry 8a and the second voltage detection circuitry 8b included in the power converter 100 according to the first embodiment.

The first voltage detection circuitry 8a and the second voltage detection circuitry 8b each includes a resistance voltage dividing circuitry 81 and an RC circuitry 82. The resistance voltage dividing circuitry 81 is for detecting a voltage input to an inverter (the first inverter 5a, the second inverter 5b). The RC circuitry 82 is a filter circuitry. The RC circuitry 82 is connected in parallel with a resistor having a resistance value of R2, which is one of two resistors included in the resistance voltage dividing circuitry 81. A filter time constant of the RC circuitry 82 included in the first voltage detection circuitry 8a and a filter time constant of the RC circuitry 82 included in the second voltage detection circuitry 8b are set based on the wire impedances Z1, Z2, Z3, and Z4 illustrated in FIG. 2, in such a way as to reduce a difference between response time required for the first drive signal generator 7a to detect an anomaly and response time required for the second drive signal generator 7b to detect an anomaly in the case of the anomalies. A time constant T[sec] of the RC circuitry 82 is determined by the product of a resistance value R[Ω] of a resistor included in a circuitry and a value C[F] of the capacitance of a capacitor included in the circuitry. Therefore, respective time constants T of the first voltage detection circuitry 8a and the second voltage detection circuitry 8b are set to different values to suppress the influence of the difference between wire impedances. Specifically, the time constant T is set to a larger value on a side with a smaller wire impedance than on a side with a larger wire impedance. This prevents a decrease in overvoltage anomaly detection responsiveness on the side with the larger wire impedance. In addition, a determination that an overvoltage anomaly has occurred is prevented from being easily made when a voltage fluctuation occurs due to noise on the side with the smaller wire impedance. Thus, a malfunction is prevented.

Note that the resistance voltage dividing circuitry 81 illustrated in FIG. 3 may be replaced with a known voltage sensor so that the first voltage detection circuitry 8a and the second voltage detection circuitry 8b are each configured as a combination of the voltage sensor and the RC circuitry 82.

Each of the first drive signal generator 7a and the second drive signal generator 7b may further have a function of determining whether a failure has occurred based on both the voltage V_{dc1} input to the first inverter 5a and the voltage V_{dc2} input to the second inverter 5b.

A description will be given of operation in which the first drive signal generator 7a and the second drive signal generator 7b detect a failure based on both the voltage V_{dc1} input to the first inverter 5a and the voltage V_{dc2} input to the second inverter 5b, and cause the first inverter 5a and the second inverter 5b to stop power conversion operation, respectively. Since the first drive signal generator 7a and the second drive signal generator 7b similarly operate, operation of the first drive signal generator 7a will be described herein.

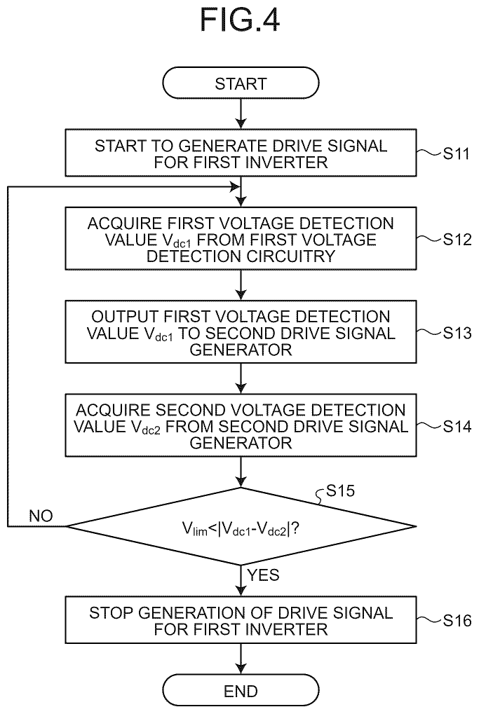

FIG. 4 is a flowchart illustrating exemplary operation of the first drive signal generator 7a included in the power converter 100 according to the first embodiment. Specifically, FIG. 4 illustrates exemplary operation of detecting a failure of the power converter 100 and causing the first inverter 5a to stop power conversion operation.

The first drive signal generator 7a starts to generate a drive signal for the first inverter 5a (step S11), and outputs the generated drive signal to the first inverter 5a. After starting generation of the drive signal, the first drive signal generator 7a first acquires a first voltage detection value V_{dc1} from the first voltage detection circuitry 8a (step S12). Furthermore, the first drive signal generator 7a outputs the first voltage detection value V_{dc1} acquired in step S12 to the second drive signal generator 7b (step S13). Note that the first voltage detection value V_{dc1} acquired in step S12 is also used in the process of generating a drive signal for the first inverter 5a.

Next, the first drive signal generator 7a acquires, from the second drive signal generator 7b, a second voltage detection value V_{dc2} detected by the second voltage detection circuitry 8b (step S14). Note that the processing in step S13 and the processing in step S14 may be performed in reverse order.

Next, the first drive signal generator 7a checks whether an absolute value of a difference between the first voltage detection value V_{dc1} and the second voltage detection value V_{dc2} is larger than a predetermined threshold value Vₗᵢₘ, that is, whether “Vₗᵢₘ<|V_{dc1}−V_{dc2}|” holds (step S15). The threshold value Vₗᵢₘ is a threshold value for determining occurrence of a failure of the power converter 100. When both the first inverter 5a and the second inverter 5b are in normal operation, there is no large difference between the first voltage detection value V_{dc1} and the second voltage detection value V_{dc2}. However, when one of the first inverter 5a and the second inverter 5b fails, there occurs a sudden change in voltage input to the inverter where an anomaly has occurred. This causes a large difference between the first voltage detection value V_{dc1} and the second voltage detection value V_{dc2}. Therefore, in step S15, the first drive signal generator 7a determines whether a failure has occurred by comparing the absolute value of the difference between the first voltage detection value V_{dc1} and the second voltage detection value V_{dc2} with the threshold value Vₗᵢₘ.

When the absolute value of the difference between the first voltage detection value V_{dc1} and the second voltage detection value V_{dc2} is equal to or less than the threshold value Vₗᵢₘ (step S15: No), the first drive signal generator 7a returns to step S12, and repeats the processing of steps S12 to S15. Furthermore, the first drive signal generator 7a continues the operation of generating a drive signal for the first inverter 5a.

In addition, when the absolute value of the difference between the first voltage detection value V_{dc1} and the second voltage detection value V_{dc2} is larger than the threshold value Vₗᵢₘ (step S15: Yes), the first drive signal generator 7a stops generation of a drive signal for the first inverter 5a (step S16), and causes the first inverter 5a to stop power conversion operation. At this time, the first drive signal generator 7a performs control such that all switching elements included in the first inverter 5a are in an off state.

Note that, in step S14 of the exemplary operation illustrated in FIG. 4, the first drive signal generator 7a acquires the second voltage detection value V_{dc2} from the second drive signal generator 7b, but the first drive signal generator 7a may be configured such that the first drive signal generator 7a acquires the second voltage detection value V_{dc2} directly from the second voltage detection circuitry 8b.

In addition, although the second drive signal generator 7b operates as with the first drive signal generator 7a to detect a failure and cause the second inverter 5b to stop power conversion operation as described above, a failure may be detected only by the first drive signal generator 7a or the second drive signal generator 7b. For example, in a case where only the first drive signal generator 7a detects a failure, step S13 illustrated in FIG. 4 is omitted, and when detecting a failure in step S15, that is, when determining that the absolute value of the difference between the first voltage detection value V_{dc1} and the second voltage detection value V_{dc2} is larger than the threshold value Vₗᵢₘ, the first drive signal generator 7a notifies the second drive signal generator 7b of detection of the failure, and executes step S16. When receiving, from the first drive signal generator 7a, the notification to the effect that the failure has been detected, the second drive signal generator 7b stops generation of a drive signal for the second inverter 5b, and causes the second inverter 5b to stop power conversion operation.

As described above, the power converter 100 according to the first embodiment includes: the converter 2 that rectifies alternating-current power; the first inverter 5a, the second inverter 5b that converts direct-current power output from the converter 2 into alternating-current power for driving connected loads; the first voltage detection circuitry 8a that acquires the first voltage detection value V_{dc1} that is a voltage value of the input portion of the first inverter 5a; the first drive signal generator 7a that generates a drive signal for the first inverter 5a based on the first voltage detection value V_{dc1}, and causes the first inverter 5a to stop operation when detecting a voltage anomaly; the second voltage detection circuitry 8b that acquires the second voltage detection value V_{dc2} that is a voltage value of the input portion of the second inverter 5b; and the second drive signal generator 7b that generates a drive signal for the second inverter 5b based on the second voltage detection value V_{dc2}, and causes the second inverter 5b to stop operation when detecting a voltage anomaly. When the first voltage detection value V_{dc1} is larger than a predetermined threshold value, the first voltage detection circuitry 8a determines that the voltage is anomalous, and when the second voltage detection value V_{dc2} is larger than a predetermined threshold value, the second voltage detection circuitry 8b determines that the voltage is anomalous. Furthermore, the first voltage detection circuitry 8a and the second voltage detection circuitry 8b include the filter circuitries that filter voltage detection values, and time constants of the filter circuitries are different. The time constant of the filter circuitry included in the first voltage detection circuitry 8a and the time constant of the filter circuitry included in the second voltage detection circuitry 8b are determined based on the wire impedances between the converter 2 and the first inverter 5a and the wire impedances between the converter 2 and the second inverter 5b, respectively.

The power converter 100 according to the first embodiment can achieve highly reliable operation by setting the respective time constants of the filter circuitries of the first voltage detection circuitry 8a and the second voltage detection circuitry 8b to different values so as to suppress the influence of the difference between the wire impedances between the converter 2 and the first inverter 5a and between the converter 2 and the second inverter 5b.

Note that the exemplary configuration illustrated in FIG. 1 assumes that the alternating-current power supply 1 connected to the power converter 100 is a three-phase alternating-current power supply, but the alternating-current power supply 1 may be a single-phase alternating-current power supply. In addition, although the configuration in which the reactor 3 (direct-current reactor) is provided on a direct-current bus connecting the converter 2 and the main circuitry capacitor 4 has been described above, an alternating-current reactor may be provided on a power supply wire connecting the alternating-current power supply 1 and the converter 2. Furthermore, although an example in which the main circuitry capacitor 4 is an electrolytic capacitor has been described, a film capacitor may be used as the main circuitry capacitor 4.

### Second Embodiment

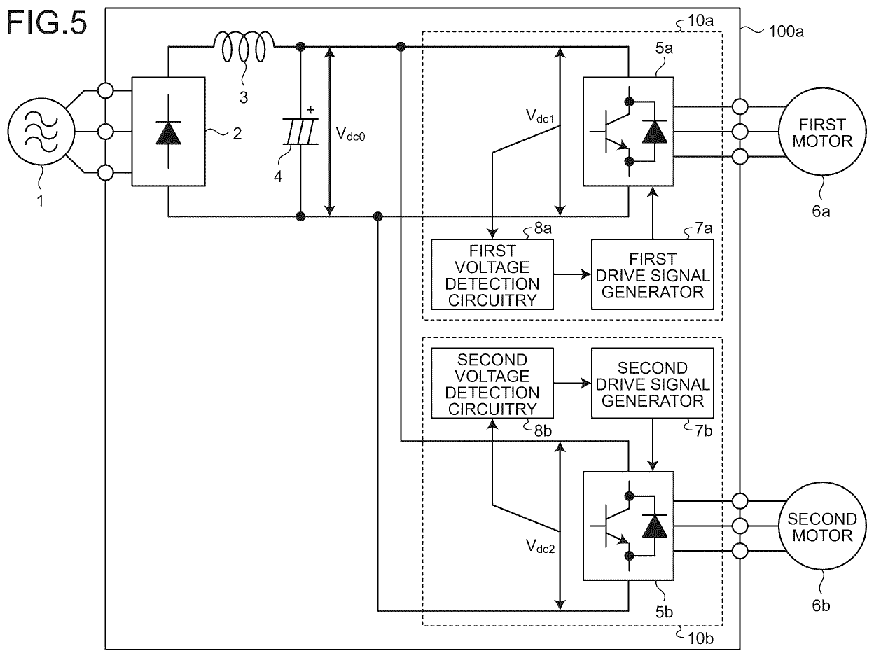

FIG. 5 is a diagram illustrating an exemplary configuration of a power converter 100a according to a second embodiment. As with the power converter 100 according to the first embodiment, the power converter 100a includes the converter 2, the reactor 3, the main circuitry capacitor 4, the first inverter 5a, the second inverter 5b, the first drive signal generator 7a, the second drive signal generator 7b, the first voltage detection circuitry 8a, and the second voltage detection circuitry 8b, and converts three-phase alternating-current power output from the alternating-current power supply 1 to generate three-phase alternating-current power for driving each of the first motor 6a and the second motor 6b.

The power converter 100a according to the second embodiment is different from the power converter 100 according to the first embodiment in that a first power conversion circuitry including the first inverter 5a, the first drive signal generator 7a, and the first voltage detection circuitry 8a is mounted on a first substrate 10a, and a second power conversion circuitry including the second inverter 5b, the second drive signal generator 7b, and the second voltage detection circuitry 8b is mounted on a second substrate 10b provided separately from the first substrate 10a.

As described above, the two power conversion circuitries including the inverters and the related peripheral circuitries are mounted on different substrates. As a result, the same effect as that of the power converter 100 according to the first embodiment can be obtained. Furthermore, since signals on the power conversion circuitries do not interfere with each other, a malfunction of the power conversion circuitry mounted on each substrate can be prevented, leading to further improvement of operation reliability.

### Third Embodiment

In the third embodiment, a description will be given of an apparatus to which each of the power converters described in the first and second embodiments is applied. An air conditioner to be implemented by application of the power converter 100 described in the first embodiment will be described as an example.

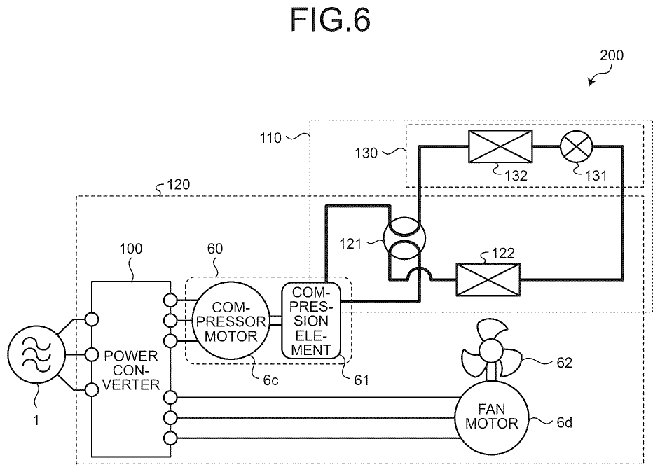

FIG. 6 is a diagram illustrating an exemplary configuration of an air conditioner 200 according to a third embodiment. The air conditioner 200 according to the third embodiment includes the power converter 100 described in the first embodiment. The power converter 100 is connected to the alternating-current power supply 1. Note that the power converter 100 may be replaced with the power converter 100a described in the second embodiment.

In addition, the air conditioner 200 includes: a compressor motor 6c and a compression element 61 that constitute the compression element 61; a fan motor 6d that rotates a fan 62; a four-way valve 121 that constitute a refrigeration cycle 110 together with the compression element 61; a heat source-side heat exchanger 122; an expander 131; and a load-side heat exchanger 132. The power converter 100, the compressor 60, the fan motor 6d, the fan 62, the four-way valve 121, and the heat source-side heat exchanger 122 are provided in an outdoor unit 120 of the air conditioner 200. The expander 131 and the load-side heat exchanger 132 are provided in an indoor unit 130 of the air conditioner 200. For example, the compressor motor 6c corresponds to the first motor 6a illustrated in FIG. 1, and the fan motor 6d corresponds to the second motor 6b illustrated in FIG. 1. Note that the configuration of the refrigeration cycle 110 is not limited to that illustrated in FIG. 6. FIG. 6 illustrates a known exemplary configuration.

In the power converter 100 to be applied to the air conditioner 200, a time constant of a filter included in a voltage detection circuitry that detects a voltage input to an inverter to which the fan motor 6d is connected is set to a value larger than a time constant of a filter included in a voltage detection circuitry that detects a voltage input to an inverter to which the compressor motor 6c is connected. Furthermore, the first drive signal generator 7a and the second drive signal generator 7b detect overvoltage anomalies by using the same threshold value.

With such a configuration, in a case where the amounts of transient change in voltages input to the inverters are equal at the time of an anomaly in the power converter 100 or 100a, the operation of the first inverter 5a on a side with a smaller filter time constant, where the compressor 60 is located, is stopped first in the air conditioner 200. Therefore, even when the first inverter 5a, which drives the compressor motor 6c, stops operation as a result of execution of operation of protection against an overvoltage anomaly, the second inverter 5b, which drives the fan motor 6d, continues operation, and the fan motor 6d also continues rotation operation. Thus, even when the compressor 60 is stopped, the cooling of the power converter 100 or 100a can be continued by wind generated by the fan 62. Accordingly, electronic components such as the switching elements included in the first inverter 5a can be protected.

Furthermore, the air conditioner 200 according to the third embodiment can reduce the risk that the air conditioner 200 may anomalously stop air conditioning operation due to a malfunction of the power converter 100 or 100a in performing protection operation. Thus, user comfort can be improved.

### Fourth Embodiment

In the power converters 100 and 100a of the air conditioner 200 according to the third embodiment, the time constants of the filter circuitries included in the first voltage detection circuitry 8a and the second voltage detection circuitry 8b are set to different values so as to absorb the influence of the difference between the wire impedances between the converter 2 and the first inverter 5a and between the converter 2 and the second inverter 5b. Meanwhile, another method may be used to absorb the influence.

For example, the first drive signal generator 7a and the second drive signal generator 7b may use different threshold values for overvoltage anomaly determination so as to absorb the influence of the difference between the wire impedances. In this case, the time constant of the filter circuitry included in the first voltage detection circuitry 8a and the time constant of the filter circuitry included in the second voltage detection circuitry 8b may be set to the same value, or may be set to different values. That is, at least either the time constants of the filter circuitries included in the voltage detection circuitries or the threshold values to be used by the drive signal generators for overvoltage anomaly determination may be set to different values so as to absorb the influence of the difference between the wire impedances between the converter 2 and the first inverter 5a and between the converter 2 and the second inverter 5b.

In a case where the threshold values to be used by the first drive signal generator 7a and the second drive signal generator 7b for overvoltage anomaly determination are set to different values so as to absorb the influence of the difference between the wire impedances between the converter 2 and the first inverter 5a and between the converter 2 and the second inverter 5b, a threshold value to be used for overvoltage anomaly determination in a drive signal generator that generates a drive signal for the inverter connected to the fan motor 6d is set to a value larger than a threshold value to be used for overvoltage anomaly determination in a drive signal generator that generates a drive signal for the inverter connected to the compressor motor 6c.

The threshold values to be used by the drive signal generators (the first drive signal generator 7a and the second drive signal generator 7b) for overvoltage anomaly determination are determined based on the wire impedances between the converter 2 and the first inverter 5a and between the converter 2 and the second inverter 5b, respectively.

Based on the premise that the power converters 100 and 100a described in the first and second embodiments, respectively, are applied to an air conditioner, the following has been described in the fourth embodiment: at least either the time constant of the filter circuitry included in each voltage detection circuitry or the threshold value to be used by each drive signal generator for overvoltage anomaly determination is adjusted to reduce an influence on operation characteristics caused by the impedance of the wire from the converter 2 to the input portion of each inverter. Meanwhile, the configuration of the fourth embodiment is not limited thereto. Similarly, when the power converters 100 and 100a are applied to other devices (devices other than air conditioners), it is possible to reduce the influence of the wire impedance on operation characteristics by adjusting at least either the time constant of the filter circuitry included in each voltage detection circuitry or the threshold value to be used by each drive signal generator for overvoltage anomaly determination.

The configurations set forth in the above embodiments show examples, and it is possible to combine the configurations with another known technique or combine the embodiments with each other, and is also possible to partially omit or change the configurations without departing from the scope of the present disclosure.

1. A power converter comprising:
a converter configured to rectify alternating-current power supplied from an alternating-current power supply;
a first inverter and a second inverter each connected to both ends of a main circuitry capacitor that is configured to smooth direct-current power output from the converter;
a first voltage detection circuitry configured to:
detect a voltage input to the first inverter; and
perform filtering of a detection value, and output the detection value as a first voltage detection value;
a second voltage detection circuitry configured to:
detect a voltage input to the second inverter;
perform filtering of a detection value; and
output the detection value as a second voltage detection value;
a first drive signal generator configured to perform, based on the first voltage detection value, operation of generating a drive signal for the first inverter and operation of protecting the first inverter when an anomaly occurs; and
a second drive signal generator configured to perform, based on the second voltage detection value, operation of generating a drive signal for the second inverter and operation of protecting the second inverter when an anomaly occurs, wherein
at least either time constants of filter circuitries or threshold values are set based on wire impedances between the converter and the first inverter and between the converter and the second inverter, wherein
the filter circuitries are configured to perform the filtering in the first voltage detection circuitry and the second voltage detection circuitry, and the threshold values are used in anomaly detection processes in the first drive signal generator and the second drive signal generator.

2. The power converter according to claim 1, wherein
the first drive signal generator and the second drive signal generator further have functions of detecting anomalies in the first inverter and the second inverter, respectively, based on a difference between the first voltage detection value and the second voltage detection value, and cause the first inverter and the second inverter to stop operation, respectively, when detecting anomalies based on the difference.

3. The power converter according to claim 1, wherein
the first voltage detection circuitry, the first drive signal generator, and the first inverter are mounted on a first substrate; and
the second voltage detection circuitry, the second drive signal generator, and the second inverter are mounted on a second substrate that is provided separately from the first substrate.

4. The power converter according to claim 1, wherein
in a case where the time constants of the filter circuitries included in the first voltage detection circuitry and the second voltage detection circuitry are set based on the wire impedances,
the time constants are set such that a time constant of a filter circuitry included in the first voltage detection circuitry is smaller than a time constant of a filter circuitry included in the second voltage detection circuitry when a wire impedance between the converter and the first inverter is larger than a wire impedance between the converter and the second inverter; and
the time constants are set such that the time constant of the filter circuitry included in the first voltage detection circuitry is larger than the time constant of the filter circuitry included in the second voltage detection circuitry when the wire impedance between the converter and the first inverter is smaller than the wire impedance between the converter and the second inverter.

5. The power converter according to claim 1, wherein
in a case where the threshold values to be used in the anomaly detection processes in the first drive signal generator and the second drive signal generator are set based on the wire impedances:
the threshold values are set such that a threshold value to be used in an anomaly detection process in the first drive signal generator is smaller than a threshold value to be used in an anomaly detection process in the second drive signal generator when a wire impedance between the converter and the first inverter is larger than a wire impedance between the converter and the second inverter; and
the threshold values are set such that the threshold value to be used in the anomaly detection process in the first drive signal generator is larger than the threshold value to be used in the anomaly detection process in the second drive signal generator when the wire impedance between the converter and the first inverter is smaller than the wire impedance between the converter and the second inverter.

6. An air conditioner comprising:
the power converter according to claim 1, wherein
the first inverter is adapted to drive a compressor motor provided in a compressor, the second inverter is adapted to drive a fan motor to rotate a fan, and the time constants are set such that a time constant of a filter circuitry included in the second voltage detection circuitry is larger than a time constant of a filter circuitry included in the first voltage detection circuitry.

7. An air conditioner comprising:
the power converter according to claim 1, wherein
the first inverter is adapted to drive a compressor motor provided in a compressor, the second inverter is adapted to drive a fan motor to rotate a fan, and the threshold values are set such that a threshold value to be used in an anomaly detection process in the second drive signal generator is larger than a threshold value to be used in an anomaly detection process in the first drive signal generator.
